(19) United States
(12) Patent Application Publication
(10) Pub. No.: US 2025/0343654 A1
(43) Pub. Date: Nov. 6, 2025

(54) CHANNEL STATE INFORMATION REPORTING METHOD AND SYSTEM

(71) Applicant: ZTE Corporation, Shenzhen (CN)

(72) Inventors: Shujuan ZHANG, Shenzhen (CN); Hongkang YU, Shenzhen (CN); Mengnan JIAN, Shenzhen (CN); Yijian CHEN, Shenzhen (CN); Yunlu WANG, Shenzhen (CN); Yuan SI, Shenzhen (CN)

(21) Appl. No.: 19/265,729

(22) Filed: Jul. 10, 2025

Related U.S. Application Data
(63) Continuation of application No. PCT/CN2023/073210, filed on Jan. 19, 2023.

(51) Int. Cl. H04L 5/00; H04B 7/06

(52) U.S. Cl. CPC H04L 5/0051; H04B 7/0634; H04B 7/0639

(57) ABSTRACT

This patent application discloses methods, apparatus, and systems that relate to reference signaling design and configuration. In one example aspect, a method for wireless communication includes receiving, by a wireless device, a measurement reference signal; determining, by the wireless device, a pre-coding matrix based on the received measurement reference signal; and transmitting, by a wireless device, information of the determined pre-coding matrix, wherein the pre-coding matrix is determined based on a first vector of length N₁ and a second vector of length N₂, wherein the first vector is determined based on a first parameter, wherein the second vector is determined based on a second parameter and the first parameter and the second parameter have relationship.

### CROSS-REFERENCE TO RELATED APPLICATION

This application is a continuation and claims priority to International Application No. PCT/CN2023/073210, filed on Jan. 19, 2023, the disclosure of which is hereby incorporated by reference herein in its entirety.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

### SUMMARY

This patent document discloses techniques, among other things, related to methods and apparatus of reporting/receiving a channel state information in a wireless communication system.

In one example aspect, a wireless communication method is disclosed. The method includes receiving, by a wireless device, a measurement reference signal; determining, by the wireless device, a pre-coding matrix based on the received measurement reference signal; and transmitting, by a wireless device, information of the determined pre-coding matrix, wherein the pre-coding matrix is determined based on a first vector of length N₁ and a second vector of length N₂, wherein the first vector is determined based on a first parameter, wherein the second vector is determined based on a second parameter and the first parameter and the second parameter have relationship.

In another example aspect, another wireless communication method is disclosed. The method includes receiving, by a wireless node from a wireless device, information of a pre-coding matrix, wherein the pre-coding matrix is determined based on a first vector of length N₁ and a second vector of length N₂, the first vector is determined based on a first parameter, wherein the second vector is determined based on a second parameter and the first parameter and the second parameter have relationship; and conducting communication with the wireless device based on the received information.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

These, and other, aspects are further described throughout the present document.

### BRIEF DESCRIPTION OF THE DRAWINGS

FIG. 1 shows an exemplary block diagram of a hardware platform that may be a part of a network device or a communication device.

FIG. 2 shows an example of network communication including a base station (BS) and user equipment (UE) based on some implementations of the disclosed technology.

FIGS. 3-6 are flowcharts representation of methods for wireless communication in accordance with one or more embodiments of the present technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 6G is used for the sake of clarity of explanation, but the techniques disclosed in the present document are not limited to 6G and may be used in wireless systems that implement other protocols.

With the evolution of 4G to 5G, the spectrum allocations have expanded towards higher frequencies. This trend will continue and communication spectra in the sub-Terahertz region will likely be available as some of the frequency bands for 6G deployments. With the introduction of these new frequencies, the number of antenna in MIMO (multiple input and multiple output) can be extreme large. In another aspect, the number of antenna used for MIMO communication will be extreme large even in lower frequency while new antenna material is used.

Especially if the extremely larger MIMO is used, the communication case includes the near field, or includes the near field and far field instead of only including the far field case in current wireless communication. Then the current channel state information (CSI) reporting method, which is suitable for the far field will not be suitable. Accordingly new method is needed.

Channel State Information Reference Signal (CSI-RS) is a reference signal (RS) that is used in the Downlink (DL) direction in 5G NR, for the purpose of Channel Sounding and used to measure the characteristics of a radio channel so that it can use correct modulation, code rate, beam forming etc. UEs will use these reference signals to measure the quality of the DL channel and report this in the UL through the CQI Reports. gNB sends CSI Reference signals to UE. UE measure the CSI-RS and report channel status information such as CSI-RSRP, CSI-RSRQ and CSI-SINR, PMI (pre-coding matrix indicator), RI (Rank indicator) for mobility procedures.

To report the CSI, codebook is introduced. The meaning of the codebook under the context is a set of precoders (a set of pre-coding Matrix). In other words, a codebook is a kind of matrix (a matrix having complex value elements) that transform the data symbol of signal (such as PDSCH (physical downlink shared channel), PDCCH (physical downlink control channel), or CSI-RS (channel state information-reference signal)) to a set of antenna ports. For example, the transmission scheme is as following.

$$[ \begin{matrix}{y}^{0} ( i ) \\ {y}^{1} ( i ) \\ ⋮ \\ {y}^{T - 1} ( i )\end{matrix} ] = {W}_{T * v} [ \begin{matrix}{s}^{0} ( i ) \\ {s}^{1} ( i ) \\ ⋮ \\ {s}^{T - 1} ( i )\end{matrix} ] \qquad ( 0 )$$

Wherein W is the pre-coding matrix which has T rows and v columns. The T is the number of antenna ports of gNB. In some implementations T is also the number of CSI-RS ports corresponding to the W. v is the rank. That v is the number of layers. y^{p}(i), p=0, 1, . . . , T−1 is the transmitted signal on the port p and i the resource element index. s^{l}(i), l=0, 1, . . . , v−1 is a symbol of layer l. The pre-coding matrix includes v columns each of which corresponds to a respective layer. Each column of the pre-coding matrix can be named a pre-coding matrix of one layer, or a pre-coding vector of one layer.

One major challenge of the current pre-coding matrix design is how to feedback channel information of the near field. Following we provide a CSI reporting method suitable for the near field case. Our method uses limited bits to report the channel state information of the near field. It saves the bit overhead of CSI reporting while the gNB can get more information about the channel because our method efficiently considered the channel feature of the near field, then the spectral will be high because the gNB can transmit signal using a parameter which is more matched with the channel. This patent application discloses multiple methods and apparatus schemes for designing a pre-coding matrix to solve this problem.

The proposed methods and schemes in the current application are beneficial in increasing the accuracy and efficiency of pre-coding matrix configuration design in communication systems. In another aspect, the complexity of UE to search optimum pre-coding matrix is reduced because we capture the feature of near filed and find some unavailable pre-coding matrixes, then the UE does not necessarily need to search pre-coding matrix only among available pre-coding matrices. In addition, we carefully consider the number of radio communication clusters of the channel and the information of each cluster. The relationship between the information of clusters is also considered. The mapping between clusters and layers are also considered.

The details of the proposed methods will be discussed in the following embodiments.

### Embodiment 1

This embodiment discloses, among other things, examples of the way to report information of the pre-coding matrix and the restrictions for the parameters involved in the pre-coding matrix.

The UE receives CSI-RS from gNB. The UE determines a pre-coding matrix based on the received CSI-RS signal.

The pre-coding matrix is based on a first vector and a second vector. The first vector includes N₁ elements, and the nth elements of the first vector can be determined by at least one of the following formats:

$${w}_{n , 1} = exp ( j ( 2 π na - 2 π {n}^{2} b ) ) , n = 0 , 1 … {N}_{1} - 1 \qquad ( 1 - 1 )$$

$${w}_{n , 1} = exp ( j ( - 2 π na + 2 π {n}^{2} b ) ) , n = 0 , 1 … {N}_{1} - 1 \qquad ( 1 - 2 )$$

$${w}_{n , 1} = exp ( j ( 2 π na + 2 π {n}^{2} b ) ) , n = 0 , 1 … {N}_{1} - 1 \qquad ( 1 - 3 )$$

$${w}_{n , 1} = exp ( - j ( 2 π na + 2 π {n}^{2} b ) ) , n = 0 , 1 … {N}_{1} - 1 \qquad ( 1 - 4 )$$

wherein 0≤a<1 and 0≤b<1

The first element of the first vector is always 1, then we can view n=0, 1, . . . , N₁−1 or n=1, . . . , N₁−1.

Accordingly, then the first vector has the following format

$${W}_{1} = [ \begin{matrix}{w}_{0 , 1} \\ {w}_{1 , 1} \\ ⋮ \\ {w}_{{N}_{1} - 1 , 1}\end{matrix} ] \qquad ( 2 )$$

The second vector includes N₂ elements and the mth elements of the first vector have following format

$${w}_{m , 1} = exp ( j ( 2 π mc - 2 π {m}^{2} d ) ) , m = 0 , 1 … {N}_{2} - 1 \qquad ( 3 - 1 )$$

$${w}_{m , 2} = exp ( j ( - 2 π mc + 2 π {m}^{2} d ) ) , m = 0 , 1 … {N}_{2} - 1 \qquad ( 3 - 2 )$$

$${w}_{m , 2} = exp ( j ( 2 π mc + 2 π {m}^{2} d ) ) , m = 0 , 1 … {N}_{2} - 1 \qquad ( 3 - 3 )$$

$${w}_{m , 2} = exp ( - j ( 2 π mc + 2 π {m}^{2} d ) ) , m = 0 , 1 … {N}_{2} - 1 \qquad ( 3 - 4 )$$

wherein 0≤c<1 and 0≤d<1

The first element of the first vector is always 1, and then we can view m=0, 1, . . . , N₂−1 or m=1, . . . , N₂−1.

Accordingly, the second vector has the following format:

$${W}_{2} = [ \begin{matrix}{w}_{0 , 2} \\ {w}_{1 , 2} \\ ⋮ \\ {w}_{{N}_{2} - 1 , 1}\end{matrix} ] \qquad ( 4 )$$

In some implementations, the UE reports the information of a and c respectively.

In one example, the a in (1-1) to (1-4) is determined by the following formula:

$$a = \frac{{m}_{1} * {O}_{1} + {q}_{1}}{{N}_{1} * {O}_{1}} , {m}_{1} ∈ \{ 0 , 1 , … , {N}_{1} - 1 \} , {q}_{1} ∈ \{ 0 , 1 , … , {O}_{1} - 1 \} \qquad ( 5 )$$

In one example, the c in (3-1) to (3-4) is determined by the following formula:

$$c = \frac{{m}_{2} * {O}_{2} + {q}_{2}}{{N}_{2} * {O}_{2}} , {m}_{2} ∈ \{ 0 , 1 , … , {N}_{2} - 1 \} , {q}_{2} ∈ \{ 0 , 1 , … , {O}_{2} - 1 \} \qquad ( 6 )$$

The UE can then report m₁, q₁ and m₂, q₂ to determine a and c, respectively.

The reported m₁, q₁ and m₂, q₂ are independent and have no combination restriction except for the combination, which is not allowed to be reported according to received signalling from gNB.

In other words, each candidate value of m, q, from N₁O₁ candidate's values of m₁, q₁ can be with any candidate value of m₂, q₂ from N₂O₂ candidate values of m₂, q₂.

Therefore, the maximum number of the allowed combinations of a and c is N₁*O₁*N₂*O₂.

In some implementations, the UE determines the candidate combination of b and d for the pre-coding matrix.

The UE reports the index of the selected combination of b and d instead of reporting b and d respectively.

The selected combination is selected by the UE from candidate combinations.

For example, if the number of candidate values of b is X and the number of candidate values of d is Y, then the number of the candidate combinations of b and d is smaller than X*Y if none of X and Y is equal to 1. That is some combination of b and d is unavailable and not reported by the UE. The number of bits used to report b and d only depends on the available combination. The number of bits is reduced and the UE complexity is also reduced because the UE only search and report pre-coding matrix among pre-coding matrixes with b and d which is in one of the candidate combinations of b and d. The UE does not search and report a pre-coding matrix with b and d which is not in any one of the candidate combinations of b and d. That is some combination of b and d is unavailable. Here unavailable combination is not same as the restricted combination determined by signaling from the gNB. The gNB can inform some restricted from the candidate combination of b and d. The unavailable combination can not depend on the signaling from gNB. The number of bits used to report the combination of b and d depends on the available candidate combinations and does not depend on the restricted combination.

For example, the difference between the b and d in one combination should be equal to or smaller than a threshold.

In some implementations, the number of combinations of b and d is the maximum value of X and Y.

For example, if there are three candidate values of b and four candidate values of d, the UE can determine candidate/available combinations of b and d as shown in Table 1. Here the number of candidate/available combinations of b and d is four instead of 12=4*3. That is, some combination, such as b=0.3 and d=0.15, is unavailable.

TABLE 1

| Combination index | b | d |
|---|---|---|
| 0 | 0.3 | 0.25 |
| 1 | 0.2 | 0.15 |
| 2 | 0.1 | 0.05 |
| 3 | 0.1 | 0.03 |

In some implementation, the b and d satisfy one of the following formula:

$$\frac{{d}^{2}}{1 - {c}^{2}} = \frac{{b}^{2}}{1 - {a}^{2}} , \frac{d}{1 - {c}^{2}} = \frac{b}{1 - {a}^{2}} , or \frac{1 - {c}^{2}}{d} = \frac{1 - {a}^{2}}{b} .$$

In some implementations, the UE reports one combination index from the C candidate combinations of b and d for the pre-coding matrix in one of the following three cases, including the first case to the third case. The first case includes Cis larger than one. The second case includes C is larger than the number of layers. The third case includes C is larger than the number of layer groups. In the second case, different layers correspond to different combinations. For the third case, different layer groups correspond to different combinations. In some implementations, the mapping between the candidate combinations of b and d layers is fixed. In some implementations, the UE reports the candidate combination for each layer or each layer group.

Accordingly, then the number of candidate combinations may be the maximum of X and Y.

In some implementations, the number of candidate values of b and the number of candidate values of d are the same.

In some implementations, the UE reports a parameter (that is the third parameter), such as e, which can be used to determine the b and d. That is, the b and d share the reported parameter e. For example, b=f₁(e), d=f₂(e), wherein f₁(e), f₂(e) are a function of e.

In some implementations, the combination of b (the first parameter) and d (the second parameter) includes the same value of b and d.

For example, one combination of b and d includes b=0.05,d=0.05.

In some implementations, the candidate values of b and d is determined by N₁ and N₂.

For example, the candidate value of one of b and d is determined by N₁ and N₂, the candidate value of another of b and d is determined by one of N₁ and N₂.

For example, if N₁>N₂, the candidate values of b is determined by N₁ and the candidate values of d is determined by N₁ and N₂. The range of candidate values of d is determined by N₁ and the number of the candidate values of d is determined by N₂. Alternatively, the range of candidate values of d is determined by N₂ and the number of the candidate values of d is determined by N₁N₁. The range of candidate value means at least one of the maximum, the minimum value, or the gap between the maximum and the minimum of the candidate value. But both the range of candidate values and the number of the candidate values b are determined by N₁.

In some implementations, the candidate value set of a and/or b depends on whether N₂ is larger than 1. For example, the candidate value set of b is first set when N₂ is 1 and the candidate value set of b is the second set when N₂ is larger than 1.

In some implementations, the candidate value set of c and/or d depends on whether N₁ is larger than 1. For example, the candidate value set of b is the first set when N₁ is 1 and the candidate value set of b is the second set when N₁ is larger than 1.

In some implementations, the sign before the a and/or b depends on whether N₂ is larger than 1. That is which of the formula (1-1) to (1-4) is adopted depends on whether N₂ is larger than 1. For example, the formula (1-1) is adopted when N₂ is 1 and the formula (1-3) is adopted when N₂ is larger than 1.

In some implementations, the sign before the c and/or d depends on whether N₁ is larger than 1. That is which of the formula (3-1) to (3-4) is adopted depends on whether N₁ is larger than 1. For example, the formula (3-1) is adopted when N₁ is 1 and the formula (3-3) is adopted when N₁ is larger than 1.

In some implementation, the b is determined by at least one of following formulas (7)-(12).

$$b = {b}_{γ} z + {b}_{1} , z ∈ [ 0 , 1 ) , or , z ∈ [ 0 , 1 ] ; \qquad ( 7 )$$

$$b = {b}_{r} \frac{y}{⌊ N * x ⌋} + {b}_{1} , y ∈ \{ 0 , 1 , … , ⌊ N * x ⌋ - 1 \} , wherein x can be a positive real number ; \qquad ( 8 )$$

$$or$$

$$b = {b}_{r} \frac{y}{N * x} + {b}_{1} , y ∈ \{ 0 , 1 , … , N * x - 1 \} , wherein x can be a positive interger . \qquad ( 9 )$$

For example, bᵣ=(bₘₐₓ−bₘᵢₙ), b₁=bₘᵢₙ

$$b = \frac{1}{{r}_{r} 𝓏 + {r}_{1}} , 𝓏 ∈ [ 0 , 1 ) , or , 𝓏 ∈ [ 0 , 1 ] ; \qquad ( 10 )$$

$$b = \frac{1}{{r}_{r \frac{y}{⌊ N * x ⌋} + {r}_{1}}} , y ∈ \{ 0 , 1 , \text{…} , ⌊ N * x ⌋ - 1 \} , wherein x can be a positive real number ; or \qquad ( 11 )$$

$$b = \frac{1}{{r}_{r \frac{y}{N * x} + {r}_{1}}} , y ∈ \{ 0 , 1 , … , N * x - 1 \} , wherein x can be a positive interger . \qquad ( 12 )$$

wherein N=max(N₁, N₂). Alternative, N=N₁.

The d has the same value of b. Alternatively, the d is determined by b. For example, d=g*b, g>0.

Here, rᵣ, r₁, bᵣ, b₁ is a real number. In some implementations, at least one of rᵣ, r₁, bᵣ, b₁ is a real number which is larger than or equal to 0. In some implementations, rᵣ>0, r₁>0, 0<bᵣ≤1, 0≤b₁≤1.

In some implementations,

$${b}_{r} = \frac{1}{4.96 \sqrt{{( N / 2 )}^{3}}} - \frac{1}{4 {N}^{2}} , {b}_{1} = \frac{1}{4 {N}^{2}} .$$

In some embodiment, at least one of rᵣ, r₁, bᵣ, b₁f is determined by signaling from gNB.

In some implementations, the candidate value of b and d is determined by the maximum value of N₁ and N₂.

For example, if N₁>N₂, the b and d is determined by the N₁. The larger the N₁, the smaller the b and d.

In some implementations, the b and d in one combination are determined by the rate between N₁ and N₂.

For example, if N₁/N₂ is larger than a threshold, the d is 0, and there is more than one candidate of b. The UE just reports the value of b.

In some implementations, b in different of the C candidate combinations of b and d are different.

In some implementations, the values of d in different C candidates combinations of b and d are different.

In some implementations, the pre-coding matrix is based on L third vectors, wherein L is an integer larger than 0. Each of the L third vectors is based on one first vector and one-second vector. For example, the pre-coding matrix is based on two weighted combinations of L third vectors. Each of the L third vectors is based on one first vector and one second vector.

The Z third vectors may correspond to L first vectors and L second vectors.

Of course, the L third vectors may correspond to less than L first vectors and less than L second vectors because the L third vectors correspond to L combinations of first vectors and second vectors.

For example, L=6, the L third vectors correspond to 1 first vector and 6 second vectors, as shown in Table 2.

In some implementations, the L third vectors correspond to 2 first vector and 3 second vectors as shown in Table 3.

In some implementations, the L third vectors correspond to 4 first vector and 5 second vectors, as shown in Table 4.

In a word, the L third vector is L combination of the first vector and the second vector. The L combination includes L₁ first vectors and L₂ second vectors, wherein 1≤L₁≤L and 1≤L₂≤L.

For reporting the L third vectors, the UE reports L combination index from N₁*N₂ combination of the first vector and the second vector. The N₁*N₂ combination of the first vector and the second vector corresponds to one value of q₁ and one value of q₂.

For example, the UE reports the L third vectors using C_{L}^{N}^{₁}^{*N}^{₂}. C_{L}^{N}^{₁}^{*N}^{₂} represents to select L values from N₁*N₂ candidate values.

TABLE 2

| The index of the third | The index of the first | The index of the first |
|---|---|---|
| vector | vector | vector |
| 0 | 0 | 1 |
| 1 | 0 | 2 |
| 2 | 0 | 3 |
| 3 | 0 | 4 |
| 4 | 0 | 5 |
| 5 | 0 | 6 |

TABLE 3

| The index of the third | The index of the first | The index of the first |
|---|---|---|
| vector | vector | vector |
| 0 | 0 | 1 |
| 1 | 1 | 1 |
| 2 | 1 | 2 |
| 3 | 1 | 3 |
| 4 | 0 | 2 |
| 5 | 0 | 3 |

TABLE 4

| The index of the third | The index of the first | The index of the first |
|---|---|---|
| vector | vector | vector |
| 0 | 0 | 1 |
| 1 | 1 | 2 |
| 2 | 2 | 3 |
| 3 | 3 | 4 |
| 4 | 4 | 1 |
| 5 | 0 | 5 |

For example, one third vector has one of the following formats:

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] , \qquad ( 13 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] + {W}_{12} \qquad ( 14 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] - {W}_{12} \qquad ( 15 )$$

wherein the n*N₂+mth element of W₁₂ (that is the fourth vector) is determined by the production of n and m. For example, W₁₂ is determined by one of the following formulas:

$${W}_{12} ( n * {N}_{2} + m ) = exp ( j 2 π nmb ) ;$$

$${W}_{12} ( n * {N}_{2} + m ) = exp ( j 4 π nmd ) ;$$

$${W}_{12} ( n * {N}_{2} + m ) = exp ( j 4 π nmf ( b , d ) )$$

$${W}_{12} ( n * {N}_{2} + m ) = exp ( j 4 π nmf ( b , d , a ) )$$

$${W}_{12} ( n * {N}_{2} + m ) = exp ( j 4 π nmf ( b , d , c ) )$$

Wherein f(b, d) is a function of b and c. For example, f(b, d)=b*d f(b,d,a) is a function of b,d,a. For example,

$$f ( b , d , a ) = - \sqrt{{( \frac{2 b}{1 - {a}^{2}} )}^{2} - ( d + b ) * \frac{4 b}{1 - {a}^{2}} + b * d * 4} .$$

f(b,d,c) is a function of b,d,c. For example,

$$f ( a , b , d ) = - \sqrt{{( \frac{2 d}{1 - {c}^{2}} )}^{2} - ( d + b ) * \frac{4 d}{1 - {c}^{2}} + b * d * 4} .$$

Here, w_{n,1}, i∈{0, 1, . . . . N₁−1} is the n^{th} element of the first vector W₁ and W₂ is the second vector. If at least one of n, m is 0, then the n*N₂+mth element of W₁₂ element is 1. It also be said that the n*N₂+mth element of W₁₂ element is determined by above formula or directly to be 1. It does not impact the novelty of the patent.

In some implementations, if at least one of N₁ or N₂ is equal to 1, then W₁₂ equals to 0 vectors. That is the third vector has the format of formula (13).

In some implementations, the L₁ first vectors included in the L third vectors correspond to one value of b. The UE can report the information of the selected one value b for the L₁ first vectors.

In some implementations, the L₂ second vectors included in the L third vectors correspond to one value of d. The UE can report the information of the selected value d for the L₂ second vector.

In some implementations, the L₁ first vectors included in the Z third vectors and the L₂ second vectors in the L third vectors correspond to one combination of b and d. The UE reports the one combination index of the selected one combination of b and d.

In some implementations, the L₁ first vectors included in the L third vectors and the L₂ second vectors in the L third vectors correspond to the same value of b and d.

In some implementations, the L₁ first vectors included in the Z third vectors and the L₂ second vectors included in the L third vectors correspond to one value of and one value d.

In some implementations, the L third vectors correspond to one value of a parameter e to determine the one value of b and the one value of d.

In some implementations, the pre-coding matrix is based on one of the following formats:

$${W}_{precoding} = [ \begin{matrix}{f}_{1} {W}_{3} \\ {f}_{2} {W}_{3}\end{matrix} ] \qquad ( 16 )$$

$${W}_{precoding} = [ \begin{matrix}{W}_{3} \\ {f}_{2} {W}_{3}\end{matrix} ] \qquad ( 17 )$$

$${W}_{precoding} = [ \begin{matrix}{\sum }_{i = 0}^{L - 1} {f}_{1}^{i} {W}_{3}^{i} \\ {\sum }_{i = 0}^{L - 1} {f}_{1}^{i} {W}_{3}^{i}\end{matrix} ] \qquad ( 18 )$$

$${W}_{precoding} = [ \begin{matrix}{f}_{1} {W}_{3}^{1} \\ {f}_{2} {W}_{3}^{2}\end{matrix} ] \qquad ( 19 )$$

$${W}_{precoding} = [ \begin{matrix}{W}_{3}^{1} \\ {f}_{2} {W}_{3}^{2}\end{matrix} ] \qquad ( 20 )$$

$${W}_{precoding} = [ \begin{matrix}{\sum }_{i = 0}^{L - 1} {f}_{1}^{i} {W}_{3}^{i} \\ {\sum }_{i = 0}^{L - 1} {f}_{1}^{i} {W}_{3}^{L + i}\end{matrix} ] \qquad ( 21 )$$

Here, fᵢ, i=1, 2 and fᵢ^{j}, i=1, 2, j=0, 1 . . . L−1 is a coefficient including amplitude and phase, or including amplitude and phase.

In some implementation, 0≤|fᵢ|≤1. 0≤|fᵢ^{j}|≤1. The difference between formulas (16) to (18) and formulas (19) to (21) is whether the two L third vector groups are different, wherein the two L third vector groups includes one for the first half CSI-RS ports and another the second half CSI-RS ports of W_{precoding}. They are the same for formulas (16) to (18). They are different for formulas (19) to (21). That is, the pre-coding matrix of one layer is based on two weighted combinations of the same groups of L third vectors for formulas (16) to (18). The pre-coding matrix of one layer is based on two weighted combinations of two groups of L third vectors for formula formulas (19) to (21). The number of third vectors for the two groups of L third vectors is the same for formula formulas (18) to (21).

In some implementations, the number of the third vectors of the two groups can be determined respectively. That is, the number of the third vectors of the two groups can be the same or different. For example, formula (18) can be replaced with formula (22), and formula (21) can be replaced with the following formula (23).

$${W}_{precoding} = [ \begin{matrix}{\sum }_{i = 0}^{{L}_{11} - 1} {f}_{1} {W}_{3}^{i} \\ {\sum }_{i = 0}^{{L}_{22} - 1} {f}_{2}^{i} {W}_{3}^{i}\end{matrix} ] \qquad ( 22 )$$

$${W}_{precoding} = [ \begin{matrix}{\sum }_{i = 0}^{{L}_{11} - 1} {f}_{1} {W}_{3}^{i} \\ {\sum }_{i = 0}^{{L}_{22} - 1} {f}_{2}^{i} {W}_{3}^{L + i}\end{matrix} ] \qquad ( 23 )$$

If the pre-coding vector of each layer has format in formula (18), the UE reports the following information for the pre-coding matrix as shown in Table 5.

TABLE 5

| | The number of the | Granularity of reporting |
|---|---|---|
| Reported information | reported information | Whether reported per |
| name | pieces | layer |
| q₁ | One selected from O₁ | No |
| | values | |
| q₂ | One selected from O₂ | No |
| | values | |
| (m₁, m₂) | L combination selected | No |
| | from N₁ * N₂ values | |
| (b, d) | One combination | No |
| | selected from one or | |
| | more than one | |
| | candidate combination | |
| | of (b, d). | |
| Coefficient | 2 L or L₁₁ + L₂₂ | Yes |

In some implementations, the UE also reports index of M frequency domain basis, wherein M is one or larger than one. Each of the M frequency domain basis includes N₃ elements, each of which corresponds to one frequency domain unit.

Then the pre-coding matrix of the frequency domain unit t, t∈{0, 1, . . . , N₃} has one of the following formats:

$${W}_{precoding , t} = [ \begin{matrix}{\sum }_{i = 0}^{{L}_{11} - 1} {W}_{3}^{i} {\sum }_{j = 0}^{M} {f}_{i , j} {e}^{j \frac{2 π {tn}_{3}^{j}}{{N}_{3}}} \\ {\sum }_{i = 0}^{{L}_{22} - 1} {W}_{3}^{i} {\sum }_{j = 0}^{M} {f}_{{L}_{11} + i , j} {e}^{j \frac{2 π {tn}_{3}^{j}}{{N}_{3}}}\end{matrix} ] {n}_{3}^{j} ∈ \{ 0 , 1 , … , {N}_{3} \} \qquad ( 24 )$$

$${W}_{precoding , t} = [ \begin{matrix}{\sum }_{i = 0}^{{L}_{11} - 1} {W}_{3}^{i} {\sum }_{j = 0}^{M} {f}_{i , j} {e}^{j \frac{2 π {tn}_{3}^{j}}{{N}_{3}}} \\ {\sum }_{i = 0}^{{L}_{22} - 1} {W}^{i + {L}_{11}} {\sum }_{j = 0}^{M} {f}_{{L}_{11} + i , j} {e}^{j \frac{2 π {tn}_{3}^{j}}{{N}_{3}}}\end{matrix} ] , {n}_{3}^{j} ∈ \{ 0 , 1 , … , {N}_{3} \} \qquad ( 25 )$$

$${W}_{precoding , t} = [ \begin{matrix}{\sum }_{i = 0}^{L - 1} {W}_{3}^{i} {\sum }_{j = 0}^{M} {f}_{i , j} {e}^{j \frac{2 π {tn}_{3}}{{N}_{3}}} \\ {\sum }_{i = 0}^{L - 1} {W}_{3}^{i} {\sum }_{j = 0}^{M} {f}_{L + i , j} {e}^{j \frac{2 π {tn}_{3}^{j}}{{N}_{3}}}\end{matrix} ] , {n}_{3}^{j} ∈ \{ 0 , 1 , … , {N}_{3} \} \qquad ( 26 )$$

$${W}_{precoding , t} = [ \begin{matrix}{\sum }_{i = 0}^{L - 1} {W}_{3}^{i} {\sum }_{j = 0}^{M} {f}_{i , j} {e}^{j \frac{2 π {tn}_{3}^{j}}{{N}_{3}}} \\ {\sum }_{i = 0}^{L - 1} {W}_{3}^{i + L} {\sum }_{j = 0}^{M} {f}_{L + i , j} {e}^{j \frac{2 π {tn}_{3}^{j}}{{N}_{3}}}\end{matrix} ] , {n}_{3}^{j} ∈ \{ 0 , 1 , … , {N}_{3} \} \qquad ( 27 )$$

wherein f_{i,j}, i∈{0, 1, . . . . L₁₁+L₂₂−1}, or i∈{0, 1, . . . 2L−1} is a coefficient. The UE reports the index n′ of the M frequency domain index.

If the pre-coding vector of each layer has a format in one of formulas (24) to (27), the UE reports the following information for the N₃ pre-coding matrix, as shown in Table 6.

TABLE 6

| Reported | The number of the | Whether |
|---|---|---|
| information | reported information | reported |
| name | pieces | per layer |
| q₁ | One selected from O₁ | No |
| | values | |
| q₂ | One selected from O₂ | No |
| | values | |
| (m₁, m₂) | L combination selected | No |
| | from N₁ * N₂ values | |
| (b, d) | One combination | No |
| | selected from one or | |
| | more than one | |
| | candidate combination | |
| | of (b, d). | |
| Coefficient | 2 L *M or (L₁₁ + L₂₂)*M | Yes |
| n₃^{j} | M or M − 1 | Yes or No |

One parameter is reported per layer means that one parameter is reported for each layer respectively. One parameter is not reported per layer means that the one reported parameter is shared by all layers. Multiple layers correspond to one (or one set) reported value of one parameter. The one (or one set) reported value of the one parameter is shared by the multiple layers.

### Embodiment 2

This section discloses, among other things, examples of a way o reporting the parameter/information of the pre-coding matrix.

This embodiment discloses, among other things, examples of the way to report information of the pre-coding matrix and the restrictions for the parameters involved in the pre-coding matrix.

The UE receives CSI-RS from gNB. The UE determines a pre-coding matrix based on the received CSI-RS signal.

The pre-coding matrix is based on a first vector and a second vector. The first vector includes N₁ elements and the nth elements of the first vector can be determined by at least one of the following formats:

$${w}_{n , 1} = exp ( j ( 2 π na - 2 π {n}^{2} b ) ) , n = 0 , 1 … {N}_{1} - 1 \qquad ( 28 )$$

$${w}_{n , 1} = exp ( j ( - 2 π na + 2 π {n}^{2} b ) ) , n = 0 , 1 … {N}_{1} - 1 \qquad ( 29 )$$

$${w}_{n , 1} = exp ( j ( 2 π na + 2 π {n}^{2} b ) ) , n = 0 , 1 … {N}_{1} - 1 \qquad ( 30 )$$

$${w}_{n , 1} = exp ( - j ( 2 π na + 2 π {n}^{2} b ) ) , n = 0 , 1 … {N}_{1} - 1 \qquad ( 31 )$$

wherein 0≤a<1 and 0≤b<1.

The first element of the first vector is always 1, then we can view n=0, 1, . . . , N₁−1 or n=1, . . . , N₁−1.

Accordingly, then the first vector has the following format

$${W}_{1} = [ \begin{matrix}{w}_{0 , 1} \\ {w}_{1 , 1} \\ ⋮ \\ {w}_{{N}_{1} - 1 , 1}\end{matrix} ] \qquad ( 32 )$$

The second vector includes N₂ elements and the mth elements of the first vector has the following format

$${w}_{m , 1} = exp ( j ( 2 π mc - 2 π {m}^{2} d ) ) , m = 0 , 1 … {N}_{2} - 1 \qquad ( 33 )$$

$${w}_{m , 2} = exp ( j ( - 2 π mc + 2 π {m}^{2} d ) ) , m = 0 , 1 … {N}_{2} - 1 \qquad ( 34 )$$

$${w}_{m , 2} = exp ( j ( 2 π mc + 2 π {m}^{2} d ) ) , m = 0 , 1 … {N}_{2} - 1 \qquad ( 35 )$$

$${w}_{m , 2} = exp ( - j ( 2 π mc + 2 π {m}^{2} d ) ) , m = 0 , 1 … {N}_{2} - 1 \qquad ( 36 )$$

wherein 0≤c<1 and 0≤d<1

The first element of the first vector is always 1; then we can view m=0, 1, . . . , N₂−1 or m=1, . . . , N₂−1.

Accordingly, the second vector has the following format:

$${W}_{2} = [ \begin{matrix}{w}_{0 , 2} \\ {w}_{1 , 2} \\ ⋮ \\ {w}_{{N}_{2} - 1 , 1}\end{matrix} ] \qquad ( 37 )$$

In some implementations, the UE reports the information of a and c respectively.

In one example, the a in (28) to (31) is determined by the following formula:

$$a = \frac{{m}_{1} * {O}_{1} + {q}_{1}}{{N}_{1} * {O}_{1}} , {m}_{1} ∈ \{ 0 , 1 , … , {N}_{1} - 1 \} , {q}_{1} ∈ \{ 0 , 1 , … , {O}_{1} - 1 \}$$

In one example, the c in (33) to (36) is determined by the following formula:

$$c = \frac{{m}_{2} * {O}_{2} + {q}_{2}}{{N}_{2} * {O}_{2}} , {m}_{2} ∈ \{ 0 , 1 , … , {N}_{2} - 1 \} , {q}_{2} ∈ \{ 0 , 1 , … , {O}_{2} - 1 \}$$

The UE can then report m₁, q₁ and m₂, q₂ to determine a and c respectively.

The reported m, q₁ and m₂, q₂ are independent and have no combination restriction except for the combination which is not allowed to be reported according to a received signaling from gNB.

In other words, each candidate value of m, q₁ from N₁O₁ candidate's values of m₁, q₁ can be with any candidate value of m₂, q₂ from N₂O₂ candidate values of m₂, q₂.

Therefore, the maximum number of the allowed combinations of a and c is N₁*O₁*N₂*O₂.

In some implementations, the pre-coding matrix is based on L third vectors, wherein L is an integer larger than 0. Each of the L third vectors is based on one first vector and one second vector. For example, the pre-coding matrix is based on two weighted combination of L third vectors. Each of the L third vectors is based on one first vector and one second vector.

The Z third vectors may correspond to L first vectors and L second vectors.

Of course, the L third vectors may correspond to less than L first vectors and less than L second vectors because the L third vectors correspond to L combinations of first vectors and second vectors.

For example, L=6, the L third vectors correspond to 1 first vector and 6 second vectors, as shown in Table 2.

In some implementations, the L third vectors correspond to 2 first vector and 3 second vectors as shown in Table 3.

In some implementations, the L third vectors correspond to 4 first vector and 5 second vectors as shown in Table 4.

In a word, the L third vector is L combination of the first vector and the second vector. The L combination includes L₁ first vectors and L₂ second vectors, wherein 1≤L₁≤L and 1≤L₂≤L.

For reporting the L third vectors, the UE reports L combination index from N₁*N₂ combination of the first vector and the second vector. The N₁* N₂ combination of the first vector and the second vector corresponds to one value of q, and one value of q₂.

For example, the UE reports the L third vectors using C_{L}^{N}^{₁}^{*N}^{₂}. C_{L}^{N}^{₁}^{*N}^{₂} represents to select L values from N₁*N₂ candidate values.

For example, one third vector has one of the following formats:

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] , \qquad ( 38 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] + {W}_{12} \qquad ( 39 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] - {W}_{12} \qquad ( 40 )$$

wherein the n*N₂+mth element of W₁₂ (that is the fourth vector) is determined by the production of n and m. For example, W₁₂ is determined by one of the following formulas:

$${W}_{12} ( n * {N}_{2} + m ) = exp ( j 2 π nmb ) ;$$

$${W}_{12} ( n * {N}_{2} + m ) = exp ( j 4 π nmd ) ;$$

$${W}_{12} ( n * {N}_{2} + m ) = exp ( j 4 π nmf ( b , d ) )$$

$${W}_{12} ( n * {N}_{2} + m ) = exp ( j 4 π nmf ( b , d , a ) )$$

$${W}_{12} ( n * {N}_{2} + m ) = exp ( j 4 π nmf ( b , d , c ) )$$

Wherein f(b, d) is a function of b and c. For example, f(b, d)=b*d f(b,d,a) is a function of b, d, a. For example,

$$f ( b , d , a ) = - \sqrt{{( \frac{2 b}{1 - {a}^{2}} )}^{2} - ( d + b ) * \frac{4 b}{1 - {a}^{2}} + b * d * 4}$$

f(b, d, c) is a function of b, d, c. For example,

$$f ( a , b , d ) = - \sqrt{{( \frac{2 d}{1 - {c}^{2}} )}^{2} - ( d + b ) * \frac{4 d}{1 - {c}^{2}} + b * d * 4}$$

Here, w_{n,1},i∈{0, 1, . . . . N₁−1} is n^{th} element of the first vector W₁ and W₂ is the second vector. If at least one of n, m is 0, then the n*N₂+mth element of W₁₂ element is 1. It also be said that the n*N₂+mth element of W₁₂ element is determined by above formula or directly to be 1. It does not impact the novelty of the patent.

In some implementations, if at least one of N₁ or N₂ is equal to 1, then W₁₂ equals to 0 vectors. That is the third vector has a format of formula (38).

In some implementations, the L₁ first vectors included in the Z third vectors correspond to one value of b. The UE can report the information of the selected one value of b for the L₁ first vectors.

In some implementations, the L₂ second vectors included in the L third vectors correspond to one value of d. The UE can report the information of the selected value of d for the L₂ second vector.

In some implementations, the L₁ first vectors included in the L third vectors and the L₂ second vectors in the L third vectors correspond to one combination of b and d. The UE reports the one combination index of the selected one combination of b and d.

In some implementations, the L₁ first vectors included in the L third vectors and the L₂ second vectors in the L third vectors correspond to the same value of b and d.

In some implementations, the L₁ first vectors included in the L third vectors and the L₂ second vectors included in the L third vectors correspond to one value of and one value d.

The pre-coding matrix of each layer can be determined by one of formula (16) to (27).

In some implementations, the L₁ first vectors included in the L third vectors correspond to one value of b. The UE can report the information of the selected one value of b for the L₁ first vectors.

In some implementations, the L₂ second vectors included in the L third vectors correspond to one value of d. The UE can report the information of the selected one value of d for the L₂ second vectors.

In some implementations, if the number of layers is larger than 1, the pre-coding matrixes for all layers share the same indication of the L₁ first vectors. Then the UE reports the information of the selected one or more than one value of b for the L₁ first vectors shared/applied for all layers. One or more than one value of b is shared by all layers. Alternatively, each layer or each layer group corresponds to the respective L₁ first vectors. The UE reports the selected one or more than one value of b for respective L₁ first vectors for each layer or each layer group.

The number of layers means the number of spatial layers each of which corresponds to one DMRS port/QCL-RS set/TCI state. The number of the layers also means the number of columns of the pre-coding matrix in the formula (0). Each layer corresponds to one column of the pre-coding matrix in formula (0). The pre-coding matrix of one layer also means one vector which is one column of the pre-coding matrix in formula (0).

In some implementations, the L₁ first vectors included in the L third vectors correspond to more than one value of b. The L third vectors is shared by all layers or only correspond to one of multiple layers.

In some implementations, each of the more than one values of b respectively corresponds to one set of first vectors. Then each of the more than one values of b respectively corresponds to one value of q₁ and one set of m₁. The UE reports information of q₁ and m₁ for each of the more than one values of b respectively.

In some implementations, the number of values of b corresponding to the L₁ first vectors depends on the received signaling from gNB.

In some implementations, if the number of layers is larger than 1, the pre-coding matrixes for all layers share same indication of the L₂ second vectors. Then the UE reports the information of the selected one or more than one value of d for the L₂ second vectors applied/used for all layers. Alternatively, each layer or each layer group corresponds to respective L₂ second vectors. The UE reports the selected one or more than one value of d for respective L₂ second vectors for each layer or each layer group.

In some implementations, the L₂ second vectors included in the L third vectors correspond to more than one value of d. In some implementations, each of the more than one value of d respectively corresponds to one set of second vectors. Then each of the more than one value of d respectively corresponds to one value of q₂ and one set of m₂. The UE reports information of q₂ and m₂ for each of the more than one value of b respectively. The L₂ second vector is shared by all layers or only corresponds to one or one group of all layers.

Then the reported information for the pre-coding matrix can be as shown in Table 7.

TABLE 7

| Reported | The number of the | |
|---|---|---|
| information | reported information | |
| name | pieces | Reported Granularity |
| q₁ | One selected from O₁ | Per each combination of |
| | values | b and d |
| q₂ | One selected from O₂ | Per each combination of |
| | values | b and d |
| (m₁, m₂) | L combination selected | Per each combination of |
| | from N₁ * N₂ values | b and d |
| b | One or more values | For all layers, or per |
| | | layer, or per layer group |
| d | One or more values | For all layers, or per |
| | | layer, or per layer group |
| Coefficient | 2 L *M or (L₁₁ + L₂₂)*M | For each layer |
| n₃^{j} | M or M − 1 | For all layers, or per |
| | | layer |

In some implementations, the L third vectors correspond to more than one combinations of b and d Each of the more than one combinations of b and d respectively corresponds to one value of q₂, one value of q₁ and one set of combinations of m and m₂. The UE reports information of one value of q₂, one value of q₁ and one set of combinations of m and m₂ for each of the more than one combination of b and d respectively. Then the reported information for the pre-coding matrix can be shown in Table 8. The L third vectors can be shared by all layers or only corresponds to one or one group of all layers.

TABLE 8

| Reported | The number of the | |
|---|---|---|
| information | reported information | |
| name | pieces | Reported Granularity |
| q₁ | One selected from O₁ | Per each combination of |
| | values | b and d |
| q₂ | One selected from O₂ | Per each combination of |
| | values | b and d |
| (m₁, m₂) | L combination selected | Per each combination of |
| | from N₁ * N₂ values | b and d |
| (b, d) | One or more | For all layers, or per |
| | combinations of (b d) | layer, or per layer group |
| Coefficient | 2 L *M or (L₁₁ + L₂₂)*M | For each layer |
| n₃^{j} | M or M − 1 | For all layers, or per |
| | | layer |

In some implementations, the number of values of d corresponding to the L₂ second vectors depends on the received signaling from gNB.

In some implementations, the number of values of combination d corresponding to the L third vectors depends on the received signaling from gNB.

In some implementations, each layer or each layer group respectively corresponds to a set of third vectors. Each set of third vectors corresponds to one or more than one value of b. Each set of third vectors corresponds to one or more than one value of d.

Alternatively, each set of third vectors corresponds to one or more than combinations of b and d. The UE reports the information of the set of third vectors for each layer or each layer group. There are one or more than one layers (or layer groups). The number of third vectors for each layer or layer group can be different. Then the W₃ⁱ, W₃^{i+L} and W₃^{i+L}^{₁₁} in (18), (21) to (27) can be replaced with W_{3,l}ⁱ, W_{3,l}^{i+L} and W_{3,l}^{i+L}^{₁₁} respectively which corresponds to one layer. l=0, 1, . . . , R−1 where R is the number of layers.

In some implementations, the number of third vectors for each layer (or layer groups) can be different. Then the L, L₁₁ in (18), (21), (22), (23) to (27) can be replaced with Lₗ, L_{11,l} l=0, 1, . . . , R−1 respectively, or be replaced with L_{g}, L_{11,g} g=0, 1, . . . , G−1 respectively. G is the number of layer groups. Then the reported information for the pre-coding matrix can be as shown in Table 9 or Table 10. In some implementations, the UE reports the number of at least one of the first vector, second vector or third vector for each layer or for each layer group, respectively.

TABLE 9

| Reported | The number of the | |
|---|---|---|
| information | reported information | Reported |
| name | pieces | granularity |
| q₁ | One selected from O | For each layer |
| | values | |
| q₂ | One selected from O₂ | For each layer |
| | values | |
| (m₁, m₂) | L combination selected | For each layer |
| | from N₁ * N₂ values | |
| b | One value | For each layer |
| d | One value | For each layer |
| Coefficient | 2 L *M or (L₁₁ + L₂₂)*M | For each layer |
| n₃^{j} | M or M − 1 | For all layers, or per |
| | | layer |

TABLE 10

| Reported | The number of the | |
|---|---|---|
| information | reported information | |
| name | pieces | Reported granularity |
| q₁ | One selected from O₁ | for each value of b, or for |
| | values | each combination of b |
| q₂ | | and d |
| q₁ | One selected from O₂ | For each value of d, or |
| | values | for each combination of |
| | | b and d |
| (m₁, m₂) | L combination selected | For each combination of |
| | from N₁ * N₂ values | b and d |
| b | One or more values | For all layers, or for each |
| | | layer, or each layer |
| | | group |
| d | One or more values | For all layers, or for each |
| | | layer, or each layer |
| | | group |
| Coefficient | 2 L *M or (L₁₁ + L₂₂)*M | For each layer |
| n₃^{j} | M or M − 1 | For each layer or for all |
| | | layers. |

If the b or d is reported for each layer or layer group respectively, then q₁, q₂ and (m₁, m₂) should be reported for each layer or layer group respectively. In some implementations, the UE reports layer indication included in each layer group corresponding to one set of third vectors.

In some implementations, the UE reports whether different layers or different layer groups share the same set of third vectors.

In some implementations, the UE determines whether different layers or different layer groups share the same set of third vectors according to received signaling from gNB.

In some implementations, each combination of b and d corresponds to one or more clusters of the channel.

In some implementation, the way of determining the first parameter and the second parameter described in Embodiment 1 can be used in this Embodiment. The feature of the first parameter and the second parameter described in Embodiment 1 can be used in this Embodiment

### Embodiment 3

The UE receives CSI-RS from gNB. The UE determines a pre-coding matrix based on the received CSI-RS signal. The pre-coding matrix is based on a first vector and a second vector. The first vector includes N₁ elements and the n^{th} element of the first vector has one of the following format as shown in formula (41-1) to (41-4):

$${w}_{n , 1} = exp ( j ( 2 π na - 2 π {n}^{2} b ) ) \qquad ( 41 - 1 )$$

$${w}_{n , 1} = exp ( j ( - 2 π na + 2 π {n}^{2} b ) ) \qquad ( 41 - 2 )$$

$${w}_{n , 1} = exp ( j ( 2 π na + 2 π {n}^{2} b ) ) \qquad ( 41 - 3 )$$

$${w}_{n , 1} = exp ( - j ( 2 π na + 2 π {n}^{2} b ) ) \qquad ( 41 - 4 )$$

wherein 0≤a<1 and 0≤b<1. The first element of the first vector is 1, and then we can view

$$n = 0 , 1 , … , {N}_{1} - 1 or n = 1 , … , {N}_{1} - 1$$

Then the first vector has the following format

$${W}_{1} = [ \begin{matrix}{w}_{0 , 1} \\ {w}_{1 , 1} \\ ⋮ \\ {w}_{{N}_{1} - 1 , 1}\end{matrix} ] \qquad ( 42 )$$

The second vector includes N₂ elements, and the mth elements of the first vector have the following format

$${w}_{m , 2} = exp ( j ( 2 π m c - 2 π {m}^{2} d ) ) \qquad ( 43 - 1 )$$

$${w}_{m , 2} = exp ( j ( - 2 π m c + 2 π {m}^{2} d ) ) \qquad ( 43 - 2 )$$

$${w}_{m , 2} = exp ( j ( 2 π m c + 2 π {m}^{2} d ) ) \qquad ( 43 - 3 )$$

$${w}_{m , 2} = exp ( - j ( 2 π m c + 2 π {m}^{2} d ) ) \qquad ( 43 - 4 )$$

wherein 0≤c<1 and 0≤d<1

The first element of the second vector is 1, then we can view

$$m = 0 , 1 , … , {N}_{2} - 1 or m = 1 , … , {N}_{2} - 1$$

Then the second vector has the following format

$${W}_{1} = [ \begin{matrix}{w}_{0 , 2} \\ {w}_{1 , 2} \\ ⋮ \\ {w}_{{N}_{2} - 1 , 1}\end{matrix} ] \qquad ( 44 )$$

In some implementations, the pre-coding matrix is based on a third vector which is based on the first vector and the second vector. For example, one-third vector has one of the following formats:

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] , \qquad ( 45 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] + {W}_{12} \qquad ( 46 )$$

$${W}_{3} = [ \begin{matrix}{w}_{0 , 1} {W}_{2} \\ {w}_{1 , 1} {W}_{2} \\ ⋮ \\ {w}_{{N}_{1} - 1 , 1} {W}_{2}\end{matrix} ] - {W}_{12} \qquad ( 47 )$$

Here, the n*N₂+m th element of W₁₂ (the fourth vector) is determined by the production of n and m, For example, W₁₂ is determined by one of the following formula:

$${W}_{12} ( m * {N}_{1} + n ) = exp ( j 2 π nmb ) ;$$

$${W}_{12} ( m * {N}_{1} + n ) = exp ( j 4 π nmd ) ; or ;$$

$${W}_{12} ( m * {N}_{1} + n ) = exp ( j 4 π nmf ( b , d ) )$$

$${W}_{12} ( m * {N}_{1} + n ) = exp ( j 4 π nmf ( b , d , a ) )$$

$${W}_{12} ( m * {N}_{1} + n ) = exp ( j 4 π nmf ( b , d , c ) )$$

Wherein f(b,d) is a function of b and c. For example, f(b,d)=b*d
f(b,d,a) is a function of b, d, a. For example,

$$f ( b , d , a ) = - \sqrt{{( \frac{2 b}{1 - {a}^{2}} )}^{2} - ( d + b ) * \frac{4 b}{1 - {a}^{2}} + b * d * 4} .$$

f(b,d,c) is a function of b,d,c. For example,

$$f ( b , d , c ) = - \sqrt{{( \frac{2 d}{1 - {c}^{2}} )}^{2} - ( d + b ) * \frac{4 d}{1 - {c}^{2}} + b * d * 4} .$$

Here, w_{n,1}, i∈{0, 1, . . . . N₁−1} is n^{th} element of the first vector W₁ and W₂ is the second vector. If at least one of n, m is 0, then the n*N₂+mth element of W₁₂ element is 1. It also be said that the n*N₂+mth element of W₁₂ element is determined by above formula or directly to be 1. It does not impact the novelty of the patent.

In some implementation, the way of determining the first parameter and the second parameter described in Embodiment 1 can be used in this Embodiment. The feature of the first parameter and the second parameter described in Embodiment 1 can be used in this Embodiment.

In some implementation, for above example 1 to example 2, each value of b (i.e the first parameter) corresponds to a group of orthogonal first vectors each of which corresponds to one respective value of a. Each value of d (i.e the second parameter) corresponds to a group of orthogonal second vectors each of which corresponds to one respective value of c. Each combination of band d corresponds to a group of orthogonal third vectors each of which corresponds to one respective combination of a and c.

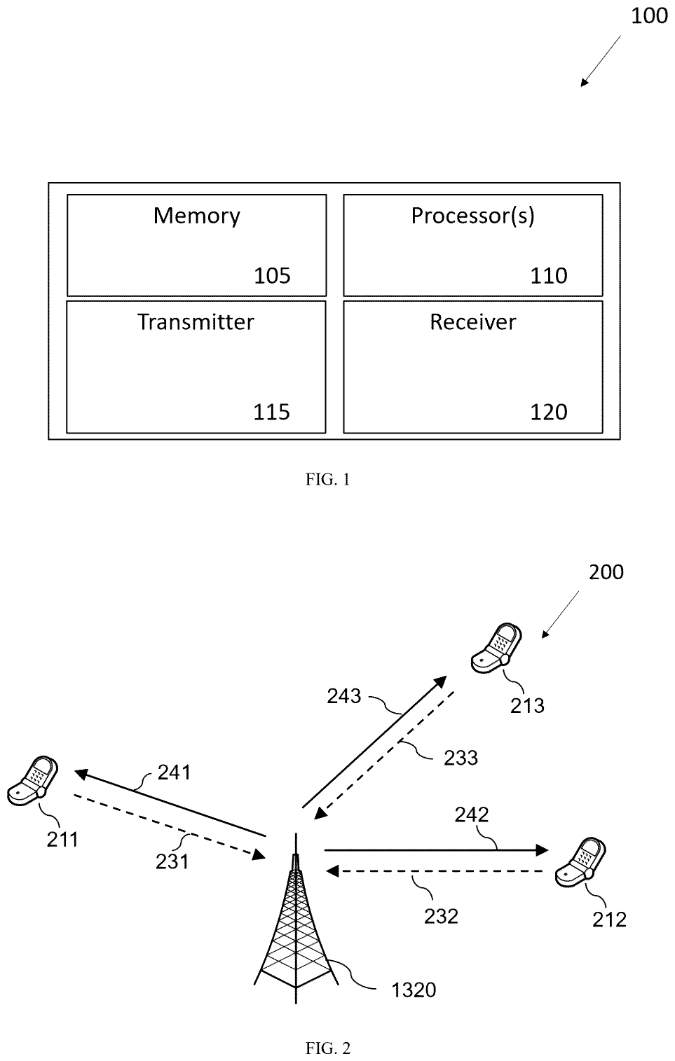

FIG. 1 shows an exemplary block diagram of a hardware platform 100 that may be a part of a network device (e.g., base station) or a communication device (e.g., user equipment (UE)). The hardware platform 100 includes at least one processor 110 and a memory 105 having instructions stored thereupon. The instructions upon execution by the processor 110 configure the hardware platform 100 to perform the operations described and in the various embodiments described in this patent document. The transmitter 115 transmits or sends information or data to another device. For example, a network device transmitter can send a message to user equipment. The receiver 120 receives information or data transmitted or sent by another device. For example, user equipment can receive a message from a network device.

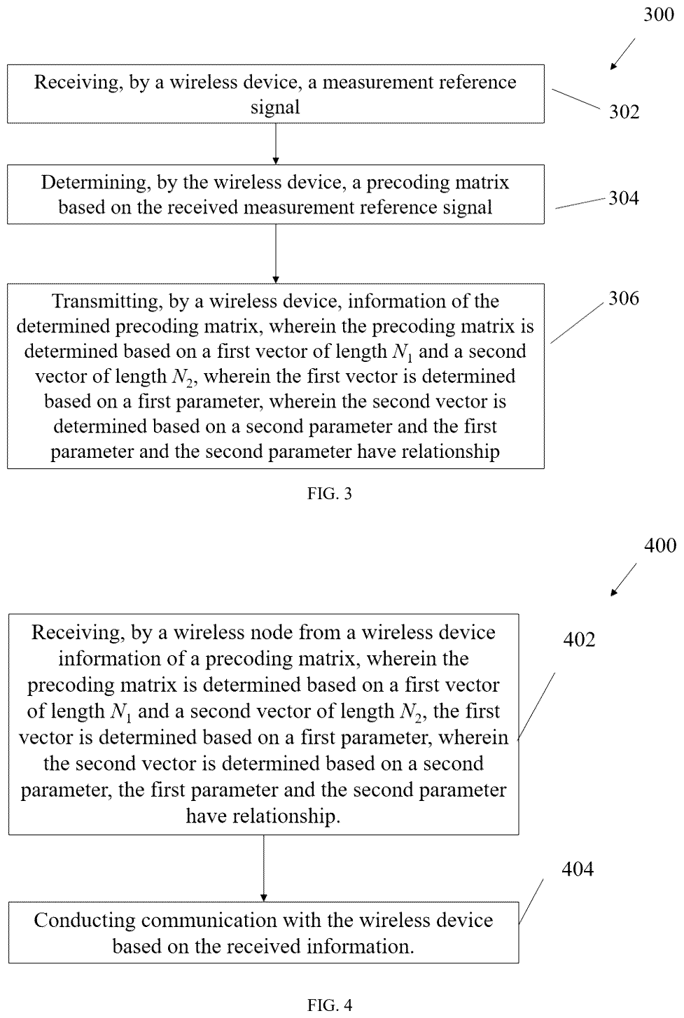

The implementations as discussed above will apply to a network communication. FIG. 2 shows an example of a communication system (e.g., a 6G or NR cellular network) that includes a base station 220 and one or more user equipment (UE) 211, 212 and 213. In some embodiments, the UEs access the BS (e.g., the network) using a communication link to the network (sometimes called uplink direction, as depicted by dashed arrows 231, 232, 233), which then enables subsequent communication (e.g., shown in the direction from the network to the UEs, sometimes called downlink direction, shown by arrows 241, 242, 243) from the BS to the UEs. In some embodiments, the BS send information to the UEs (sometimes called downlink direction, as depicted by arrows 241, 242, 243), which then enables subsequent communication (e.g., shown in the direction from the UEs to the BS, sometimes called uplink direction, shown by dashed arrows 231, 232, 233) from the UEs to the BS. The UE may be, for example, a smartphone, a tablet, a mobile computer, a machine to machine (M2M) device, an Internet of Things (IoT) device, and so on.

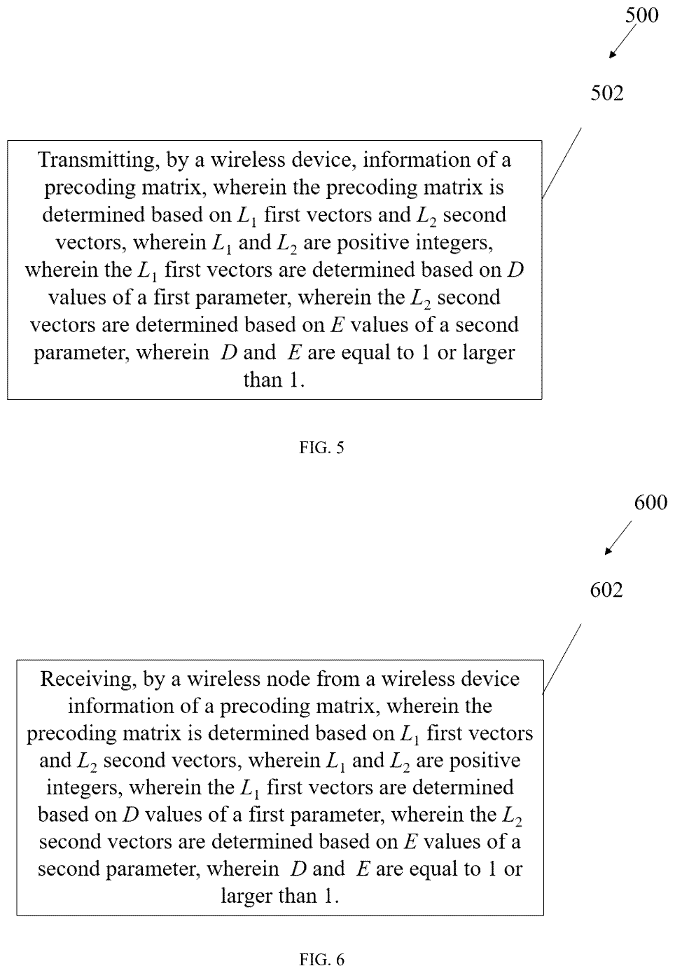

Various preferred embodiments and additional features of the above-described method of FIGS. 3-6 are as follows. Further examples are described with reference to embodiments 1 to 3.

In one example aspect (e.g., as depicted in FIG. 3), a wireless communication method is disclosed. The method includes receiving (302), by a wireless device, a measurement reference signal; determining (304), by the wireless device, a pre-coding matrix based on the received measurement reference signal; and transmitting (306), by a wireless device, information of the determined pre-coding matrix, wherein the pre-coding matrix is determined based on a first vector of length M and a second vector of length N₂, wherein the first vector is determined based on a first parameter, wherein the second vector is determined based on a second parameter and the first parameter and the second parameter have relationship.

The wireless device can be a UE or other equipment.

In another example aspect (e.g., as depicted in FIG. 4), another wireless communication method is disclosed. The method includes receiving (402), by a wireless node from a wireless device, information of a pre-coding matrix, wherein the pre-coding matrix is determined based on a first vector of length N₁ and a second vector of length N₂, the first vector is determined based on a first parameter, wherein the second vector is determined based on a second parameter and the first parameter and the second parameter have relationship; and conducting (404) communication with the wireless device based on the received information.

In another example aspect (e.g., as depicted in FIG. 5), another wireless communication method is disclosed. The method includes receiving (502), by a wireless device, a measurement reference signal; determining (504), by the wireless device, a pre-coding matrix based on the received measurement reference signal; and transmitting (506), by a wireless device, information of a pre-coding matrix, wherein the pre-coding matrix is determined based on L₁ first vectors and L₂ second vectors, wherein L₁ and L₂ are positive integers, wherein the L1 first vectors are determined based on D values of a first parameter, wherein the L₂ second vectors are determined based on E values of a second parameter, wherein D and E are equal to 1 or larger than 1.

In another example aspect (e.g., as depicted in FIG. 6), another wireless communication method is disclosed. The method includes receiving (602), by a network device, an information of a pre-coding matrix, wherein the pre-coding matrix is determined based on L₁ first vectors and L₂ second vectors, wherein L₁ and L₂ are positive integers, wherein the L₁ first vectors are determined based on D values of a first parameter, wherein the L₂ second vectors are determined based on E values of a second parameter, wherein D and E are equals to 1 or larger than 1.

In some embodiments, the first parameter is larger or equal to zero and smaller than one.

In some embodiments, the second parameter is larger or equal to zero and smaller than one.

In some embodiments, the above methods further comprising: determining, by the wireless device, C candidate combinations, wherein each of the C combinations includes one value of the first parameter and one value of the second parameter and C is a positive integer; and reporting, by the wireless device, one or more combination indexes selected from the more than one candidate combinations for at least one of the pre-coding matrix, each layer, or each layer group.

In some embodiments, the above methods further comprising: determining, by the wireless node, C candidate combinations, wherein each combination includes one first parameter and one second value and C is a positive integer; and receiving, by the wireless node, one or more combination indexes selected from the more than one candidate combinations for at least one of the pre-coding matrix, each layer, or each layer group in case where C satisfies predefined feature.

In some embodiments, the C candidate combinations of the first parameter and the second parameter is determined by the wireless device or the wireless node based on at least one of a signaling from the wireless node, a rule or a table agreed by the wireless device and the wireless node. In some embodiments, the rule includes determining by the wireless device or the wireless device, at least one of the first parameter and the second parameter based on N₁ and N₂. In some embodiments, the first parameter is determined by N₁ and N₂, wherein the second parameter is determined based on one of N₁ or N₂. In some embodiments, at least one of the number of candidate values of the first parameter and the number of candidate values of the second parameter are determined by the larger of N₁ and N₂. In some embodiments, at least one of the candidate value set of the first parameter and the candidate value set of the second parameter are determined by the larger of N₁ and N₂. In some embodiments, the first parameter and the second parameter is determined by at least one of
1) the candidate value set of the first parameter depends on the relationship between N₂ and 1; or
2) the candidate value set of the second parameter depends on the relationship between N₁ and 1.

In some embodiments, the number of the combination indexes reported by the wireless device for at least one of the pre-coding matrix, each layer, or each layer group, is determined by a signaling from the wireless node.

In some embodiments, the number of the combination indexes reported by the wireless device for at least one of the pre-coding matrix, each layer, or each layer group, is reported by the wireless device to the wireless node.

In some embodiments, each of the combination index respectively corresponds to an indication for the first vector and the second vector.

In some embodiments, the rule comprises at least one of:
1) C is smaller than X*Y, wherein X is the number of candidate values of the first parameter and Y is the number of candidate values of the second parameter;
2) C is the maximum value of X and Y;
3) the difference of the first parameter and the second parameter in each of the C candidate combinations is smaller than a threshold;
4) The first parameter and the second parameter have same value in each of the C candidate combinations;
5) the values of the first parameter in different of the C candidate combinations are different; or
6) the values of the second parameter in different of the C candidate combinations are different.

In some embodiments, determining by the wireless device or the wireless device, at least one of the first parameter and the second parameter based on N1 and N2.

In some embodiments, the first parameter is determined by N1 and N2, wherein the second parameter is determined based on one of N1 or N2.

In some embodiments, at least one of the number of candidate values of the first parameter and the number of candidate values of the second parameter are determined by the larger of N1 and N2.

In some embodiments, at least one of the candidate value set of the first parameter and the candidate value set of the second parameter are determined by the larger of N1 and N2.

In some embodiments, the first parameter and the second parameter is determined by at least one of
1) the candidate value set of the first parameter depends on the relationship between N2 and 1; or
2) the candidate value set of the second parameter depends on the relationship between N1 and 1.

In some embodiments, the number of candidate values of the first parameter is determined by N1 and the candidate value set of the first parameter is determined by N2 in case where N2 is larger than N1 or the ratio of N2 to N1 is larger than a threshold; or the number of candidate values of the second parameter is determined by N2 and the candidate value set of the first parameter is determined by N2 in case where N1 is larger than N2 or the ratio of N1 to N2 is larger than a threshold.

In some embodiments, at least one of the first parameter and the second parameter are determined based on a ratio of N1 to N2.

In some embodiments, the second parameter is zero when the ratio of N1 to N2 is larger than a predefined threshold; or the first parameter is zero when the ratio of N2 to N1 is larger than a predefined threshold.

In some embodiments, the first parameter has a same value of the second parameter.

In some embodiments, a difference between the first parameter and the second parameter is smaller than or equal to a predefined threshold.

In some embodiments, the information of the pre-coding matrix comprises a third parameter that is used to determine the first parameter and the second parameter.

In some embodiments, the pre-coding matrix is based on the first vector and the second vector comprises the pre-coding matrix is based on L third vectors of length N1*N2, each of the L third vectors is based on one of the first vector and one of the second vector, wherein L is larger than zero.

In some embodiments, each of the L third vectors is further based on a fourth vector of length N1*N2, wherein n*N₂+m element of the fourth vector is based on m*n, wherein n=0, 1, . . . , N₁−1 or n=1, . . . , N₁−1, and m=0, 1, . . . , N₂−1 or m=1, . . . , N₂−1

In some embodiments, n*N₂+m element of the fourth vector is further based on at least one of 1) the first parameter 2) a fourth parameter 3) the second parameter or 4) a function of the first parameter and a fourth parameter.

In some embodiments, the one or more combination indexes is reported by the wireless device in case where C satisfies predefined feature, wherein C satisfies predefined feature comprises at least one of following:
1) C is larger than 1;
2) C is larger than a number of layers of the pre-coding matrix; or
3) C is larger than a number of layer groups of the pre-coding matrix.

In some embodiments, each of the more combination indexes respectively corresponds to one respective set of the first vectors and one respective set of the second vectors.

In some embodiments, the above disclosed methods further comprising: transmitting, by the wireless device, a third parameter, wherein the first parameter and the second parameter are determined by a third parameter.

In some embodiments, the first parameter and the second parameter have relationship comprises at least one of:
1) the first parameter and the second parameter are the same parameter;
2) the first parameter and the second parameter have same value for the pre-coding matrix;
3) the number of candidate values of the first parameter and the number of candidate value of the second parameter is same;
4) the first parameter is determined by the second parameter; or
5) the first parameter and the second parameter is reported by an same indicator;
6) the first parameter and the second parameter is determined by a same parameter; or
7) the second parameter is determined by the first parameter;
8) At least one of the first parameter and the second parameter is determined by at least one of N₁ and N₂, a ratio of N₁ and N₂, or larger value of N₁ and N₂.

In some embodiments, the n^{th} element of the N₁ elements of the first vector is determined by the first parameter and square of n, wherein n=0, 1, . . . , N₁−1 or n=1, . . . , N₁−1

In some embodiments, the n^{th} element of the N1 elements of the first vector has one of following format:

$${w}_{n , 1} = exp ( j ( 2 π na - 2 π {n}^{2} b ) )$$

$${w}_{n , 1} = exp ( j ( - 2 π na + 2 π {n}^{2} b ) )$$

$${w}_{n , 1} = exp ( j ( 2 π na + 2 π {n}^{2} b ) )$$

$${w}_{n , 1} = exp ( - j ( 2 π na + 2 π {n}^{2} b ) )$$

wherein b is the first parameter.

In some embodiments, the mth element of the N2 elements of the second vector is determined by the second parameter and square of m, wherein m=0, 1, . . . , N₂−1 or m=1, . . . , N₂−1, wherein the b is the first parameter.

In some embodiments, the mth element of the N2 elements of the first vector has one of following format

$${w}_{n , 2} = exp ( j ( 2 π nc - 2 π {n}^{2} d ) )$$

$${w}_{n , 2} = exp ( j ( - 2 π nc + 2 π {n}^{2} d ) )$$

$${w}_{n , 2} = exp ( j ( 2 π nc + 2 π {n}^{2} d ) )$$

$${w}_{n , 2} = exp ( - j ( 2 π nc + 2 π {n}^{2} d ) )$$

wherein d is the second parameter.

In some embodiments, the first parameter and the second parameter have relationship comprises

$$\frac{d}{1 - {c}^{2}} = \frac{b}{1 - {a}^{2}} or \frac{1 - {c}^{2}}{d} = \frac{1 - {a}^{2}}{b} .$$

In some embodiments, E is smaller than L2.

In some embodiments, D is equals to E.

In some embodiments, each of the D values of the first parameter corresponds to a set of first vectors

In some embodiments, the information of the pre-coding matrix includes an indication of fourth parameter for each of the D values of the first parameter.

In some embodiments, each of the E values of the first parameter corresponds to a set of second vectors.

In some embodiments, the information of the pre-coding matrix includes an indication of fourth parameter for each of the E values of the second parameter.

In some embodiments, each column of the pre-coding matrix corresponds to one of the D values and one of the E values.

In some embodiments, L1 first vectors and L2 second vectors are applied by all layers.

In some embodiments, each layer corresponds to its respective L1 first vectors and L2 second vectors.

In some embodiments, D is smaller than L1.

It will be appreciated that the present document discloses methods and apparatus related to channel state information reporting in communication systems. One major challenge of in this area is related to pre-coding matrix design and reporting information of the pre-coding matrix. Specifically, the issue is how to feedback channel state information of the near field. This patent application discloses multiple methods and apparatus schemes for the design of pre-coding matrix to solve this problem. The proposed methods and schemes in the current application are beneficial in increasing accuracy and efficiency of pre-coding matrix configuration design in communication systems. In another aspect, the complexity of UE to search optimum pre-coding matrix is reduced because we capture the feature of near filed and find some unavailable pre-coding matrixes, then the UE does not necessary to search pre-coding matrix only among available pre-coding matrix. In addition, we carefully consider the number of radio communication cluster of the channel and the information of each cluster. The relationship between information of clusters are also considered. The mapping between clusters and layers are also considered.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
receiving, by a wireless device, a first measurement reference signal;
determining, by the wireless device, a first pre-coding matrix based on the first measurement reference signal; and
transmitting, by the wireless device, information of the first pre-coding matrix, wherein the first pre-coding matrix is determined based on a first vector of length N₁ and a second vector of length N₂, wherein the first vector is determined based on a first parameter, wherein the second vector is determined based on a second parameter, and wherein the first parameter and the second parameter have relationship.

2. The method of claim 1, further comprising:
receiving, by the wireless device, a second measurement reference signal;
determining, by the wireless device, a second pre-coding matrix based on the second measurement reference signal; and
transmitting, by the wireless device, information of the second pre-coding matrix, wherein the second pre-coding matrix is determined based on L₁ first vectors and L₂ second vectors, wherein L₁ and L₂ are positive integers, wherein the L₁ first vectors are determined based on D values of the first parameter, wherein the L₂ second vectors are determined based on E values of the second parameter, and wherein D and E are greater than or equal to 1.

3. The method of claim 1, further comprising:
determining, by the wireless device, C candidate combinations, wherein each of the C candidate combinations includes one value of the first parameter and one value of the second parameter, and wherein C is a positive integer; and
reporting, by the wireless device, one or more combination indexes selected from the C candidate combinations for the first pre-coding matrix, each layer, or each layer group in case that C satisfies a predefined feature.

4. The method of claim 3, wherein a number of the one or more combination indexes is determined by a signaling from a network device.

5. The method of claim 3, wherein a number of the one or more combination indexes is reported by the wireless device to a network device.

6. The method of claim 3, wherein each of the one or more combination indexes respectively corresponds to an indication for the first vector and the second vector.

7. The method of claim 1, wherein the wireless device or a network device is configured to determine at least one of the first parameter and the second parameter based on N₁ and N₂.

8. The method of claim 1, wherein the first parameter is determined based on N₁ and N₂, and wherein the second parameter is determined based on one of N₁ or N₂.

9. The method of claim 1, wherein the first pre-coding matrix is based on L third vectors of length N₁*N₂, wherein each of the L third vectors is based on one of a plurality of first vectors that include the first vector and one of a plurality of second vectors that include the second vector, and wherein L is greater than zero.

10. The method of claim 9, wherein each of the L third vectors is further based on a fourth vector of length N₁*N₂, wherein an (n·N₂+m)-th element of the fourth vector is based on m*n, wherein n=0, 1, . . . , N₁−1 or n=1, . . . , N₁−1, and m=0, 1, . . . , N₂−1 or m=1, . . . , N₂−1.

11. The method of claim 3, wherein C satisfying the predefined feature comprises at least one of:
(a) C being greater than 1;
(b) C being greater than a number of layers of the first pre-coding matrix; or
(c) C being greater than a number of layer groups of the first pre-coding matrix.

12. A method for wireless communication, comprising:
receiving, by a network device from a wireless device, information of a first pre-coding matrix, wherein the first pre-coding matrix is determined based on a first vector of length N₁ and a second vector of length N₂, the first vector is determined based on a first parameter, wherein the second vector is determined based on a second parameter, and wherein the first parameter and the second parameter have relationship; and
conducting communication with the wireless device based on the information of the first pre-coding matrix.

13. The method of claim 12, further comprising:
receiving, by the network device, an information of a second pre-coding matrix, wherein the second pre-coding matrix is determined based on L₁ first vectors and L₂ second vectors, wherein L₁ and L₂ are positive integers, wherein the L₁ first vectors are determined based on D values of the first parameter, wherein the L₂ second vectors are determined based on E values of the second parameter, wherein D and E are equals to 1 or larger than 1,
wherein each of C candidate combinations includes one value of the first parameter and one value of the second parameter, wherein C is a positive integer, and
wherein the wireless device is configured to report one or more combination indexes selected from the C candidate combinations for the first pre-coding matrix, each layer, or each layer group in case that C satisfies a predefined feature.

14. The method of claim 13, wherein a number of one or more combination indexes selected from the C candidate combinations for the first pre-coding matrix, each layer, or each layer group is determined by a signaling from a network device.

15. The method of claim 13, wherein a number of one or more combination indexes selected from the C candidate combinations for the first pre-coding matrix, each layer, or each layer group is reported by the wireless device to a network device.

16. The method of claim 13, wherein each of one or more combination indexes selected from the C candidate combinations for the first pre-coding matrix, each layer, or each layer group, respectively, corresponds to an indication for the first vector and the second vector.

17. The method of claim 12, wherein the wireless device or a network device is configured to determine at least one of the first parameter or the second parameter based on N₁ and N₂.

18. The method of claim 12, wherein the first parameter is determined based on N₁ and N₂, and wherein the second parameter is determined based on one of N₁ or N₂.

19. The method of claim 12, wherein the first pre-coding matrix is based on L third vectors of length N₁*N₂, wherein each of the L third vectors is based on one of a plurality of first vectors that include the first vector and one of a plurality of second vectors that include the second vector, wherein L is greater than zero, wherein each of the L third vectors is further based on a fourth vector of length N₁*N₂, wherein an (n·N₂+m)-th element of the fourth vector is based on m*n, and wherein n=0, 1, . . . , N₁−1 or n=1, . . . , N₁−1, and m=0, 1, . . . , N₂−1 or m=1, . . . , N₂−1.

20. The method of claim 13, wherein C satisfying the predefined feature comprises at least one of:
(a) C being greater than 1;
(b) C being greater than a number of layers of the first pre-coding matrix; or
(c) C being greater than a number of layer groups of the first pre-coding matrix.
